(19) United States
(12) Patent Application Publication
(10) Pub. No.: US 2009/0013962 A1
(43) Pub. Date: Jan. 15, 2009

(54) In-Cylinder Injection Type Spark Ignition-Internal Combustion Engine

(75) Inventors: Takeshi Ashizawa, Yokohama-shi (JP); Osamu Tomino, Susono-shi (JP); Hiroshi Nomura, Gotenba-shi (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, Toyota-shi (JP)

(21) Appl. No.: 12/224,603

(22) PCT Filed: Apr. 27, 2007
(86) PCT No.: PCT/IB2007/001098

§ 371 Date: Sep. 2, 2008

(30) Foreign Application Priority Data
May 1, 2006 (JP) 2006-127353

(51) Int. Cl. F02B 31/00

(52) U.S. Cl. 123/306

(57) ABSTRACT

An in-cylinder-injection type spark-ignition internal combustion engine has a fuel injection valve and an ignition plug that are arranged substantially in the upper area of the cylinder. Fuel is injected from the fuel injection valve in the flow direction of the tumble flow that swirls in the cylinder by flowing downward through the exhaust valve side of the cylinder bore and upward through the intake valve side of the cylinder bore, so as to intensify the tumble flow.

### BACKGROUND OF THE INVENTION

1. Field of the Invention

The invention relates to an in-cylinder injection type spark-ignition internal combustion engine.

2. Description of the Related Art

An internal combustion engine performs homogenous combustions by producing a homogenous air-fuel mixture and burning it at the end of each compression stroke. The conditions of such homogeneous combustions can be improved by increasing the combustion speed. The combustion speed, for example, can be increased by maintaining the movement of intake air in the cylinder until the ignition time at the end of each compression stroke by producing an intake tumble flow from the intake air drawn into the cylinder and maintaining the produced tumble flow until the ignition time.

For example, Japanese patent application publication No. JP-A-2005-180247 describes an in-cylinder injection type spark-ignition internal combustion engine that, in order to maintain tumble flows until the ignition time at the end of each compression stroke, has an intake flow control valve in the intake port and produces strong tumble flows in the cylinders by guiding, via the intake flow control valve, intake air to flow along the upper wall of the intake port and enter each cylinder.

In the in-cylinder injection type spark-ignition internal combustion engine described above, when the intake air is guided by the intake flow control valve to flow along the upper wall of the intake port and enter each cylinder, the intake port is narrowed down by the intake flow control valve. In this engine, strong tumble flows can be produced without problems when the required amount of intake air is relatively small. However, when the required amount of intake air is relatively large, because there is a possibility that a shortage of intake air may be caused if the intake port is narrowed down by the intake flow control valve, strong tumble flows can not be produced in the cylinders by the intake flow control valve.

To counter this, rather than having the intake flow control valve described above, it is possible to intensify the tumble flow, which swirls in a cylinder by flowing downward through the exhaust valve side of the cylinder bore and upward through the intake valve side, by the thrust force of fuel that is injected at the end of an intake stroke to the exhaust valve side of the cylinder bore from a fuel injection valve arranged substantially at the center of the upper area in the cylinder.

However, the intensities of the tumble flows produced in the cylinder vary as the kinetic energy of intake air drawn into the cylinder changes according to the operation conditions of the internal combustion engine. Thus, in the case where a large thrust force of injected fuel is set, when tumble flows with relatively low intensities start to be produced in the cylinder, injected fuels may penetrate the tumble flows and adhere to the wall of the cylinder bore, which may cause dilution of the engine oil. On the other hand, in the case where a small thrust force of injected fuel is set, when tumble flows with relatively high intensities start to be produced in the cylinder, it becomes impossible to intensify the tumble flows.

### SUMMARY OF THE INVENTION

The invention provides an in-cylinder-injection type spark-ignition internal combustion engine that can maintain the movement of intake air until the ignition time using tumble flows regardless of the required amount of intake air.

A first aspect of the invention relates to an in-cylinder-injection type spark-ignition internal combustion engine having a fuel injection valve and an ignition plug that are arranged in an upper area of a cylinder. In this internal combustion engine, the fuel injection valve injects fuel substantially in the flow direction of the tumble flow so as to intensify the tumble flow that swirls in the cylinder by flowing downward through the exhaust valve side of the cylinder bore of the cylinder and upward through the intake valve side of the cylinder bore.

The in-cylinder-injection type spark-ignition internal combustion engine described above may be such that the fuel injection valve is arranged in the exhaust valve side of the upper area of the cylinder and the fuel injection valve is adapted to inject fuel downward substantially in the axial direction of the cylinder.

According to the in-cylinder-injection type spark-ignition internal combustion engine described above, the fuel injection valve arranged in the exhaust valve side of the upper area of the cylinder injects fuel downward substantially in the axial direction of the cylinder, so that the tumble flow is intensified. As such, the tumble flow, regardless of the required intake amount, can remain until the ignition time, and therefore the movement of intake flow is maintained until the ignition time and the combustion speed increases accordingly.

The in-cylinder-injection type spark-ignition internal combustion engine described above may be such that the internal combustion engine includes two exhaust valves and the fuel injection valve is arranged between the two exhaust valves.

According to this in-cylinder-injection type spark-ignition internal combustion engine, because the fuel injection valve is arranged between the two exhaust valves, the fuel injection valve can be easily disposed in position in the exhaust valve side of the upper area of the cylinder.

The in-cylinder-injection type spark-ignition internal combustion engine described above may be such that the internal combustion engine includes a single exhaust valve, the fuel injection valve is provided in plurality, and the fuel injection valves are provided on both sides of the single exhaust valve, respectively.

According to this in-cylinder-injection type spark-ignition internal combustion engine, because two fuel injection valves are provided on both sides of the single exhaust valve, respectively, the two fuel injection valves can be easily disposed in positions in the exhaust valve side of the upper area of the cylinder, and the tumble flow can be further intensified by the fuels injected from the two fuel injection valves, respectively.

The in-cylinder-injection type spark-ignition internal combustion engine described above may be such that the fuel injection valve is arranged substantially at the center of the upper area of the cylinder so as to inject fuel to the exhaust valve side of the cylinder bore at an end of an intake stroke and the fuel injection valve is adapted to inject fuel at a lower injection rate when the kinetic energy of intake air drawn into the cylinder is small than when the kinetic energy is large.

According to this in-cylinder-injection type spark-ignition internal combustion engine, the fuel injection valve injects fuel to the exhaust valve side of the cylinder bore at the end of the intake stroke so as to intensify the tumble flow and the injection rate of fuel to be injected from the fuel injection valve is smaller when the kinetic energy of intake air drawn into the cylinder is small than when the kinetic energy is large. Therefore, when the kinetic energy of intake air drawn into the cylinder is small and the intensity of the tumble flow is therefore relatively low, the injection rate of the fuel injected from the fuel injection valve is reduced, so that the thrust force of the injected fuel decreases accordingly. This reduces the possibility of the injected fuel penetrating the tumble flow and adhering to the wall of the cylinder bore. In this case, further, because the intensity of the tumble flow is relatively low, the tumble flow can be reliably intensified even by the small thrust force of the injected fuel. On the other hand, when the kinetic energy of intake air drawn into the cylinder is large and the intensity of the tumble flow is therefore relatively high, the injection rate of fuel is increased, so that the thrust force of the injected fuel increases accordingly. In this case, further, because the intensity of the tumble flow is relatively high, even if the thrust force of the injected fuel is increased, it is difficult for the injected fuel to penetrate the tumble flow. Thus, the possibility of adherence of injected fuels to the wall of the cylinder bore is reduced.

The in-cylinder-injection type spark-ignition internal combustion engine described above may be such that the injection rate is reduced as the kinetic energy decreases.

According to this in-cylinder-injection type spark-ignition internal combustion engine, because the injection rate is reduced as the kinetic energy decreases, the thrust force of the injected fuel decreases as the intensity of the tumble flow decreases. Thus, tumble flows are more reliably intensified by injected fuels and the possibility of adherence of the injected fuel to the wall of the cylinder bore is sufficiently reduced.

The in-cylinder-injection type spark-ignition internal combustion engine described above may be such that the lift of a valve body of the fuel injection valve is controlled in two steps of a large lift and a small lift and the fuel injection valve is adapted to inject fuel at the maximum injection rate by lifting up the valve body by the large lift, at the minimum injection rate by lifting up the valve body by the small lift, and at an injection rate between the maximum injection rate and the minimum injection rate by lifting up the valve body first by one of the large lift and the small lift and then by the other in a row.

According to this in-cylinder-injection type spark-ignition internal combustion engine, the lift of the valve body of the fuel injection valve can be controlled in two steps: the large lift and the small lift, and the fuel injection valve is adapted to inject fuel at the maximum injection rate by lifting up the valve body by the large lift, at the minimum injection rate by lifting up the valve body by the small lift, and at an injection rate between the maximum injection rate and the minimum injection rate by lifting up the valve body first by one of the large lift and the small lift and then by the other in a row. Therefore, the injection rate can be changed in multiple steps in accordance with the intensity of the tumble flow also by controlling the lift of the valve body in two steps.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a vertical sectional view showing an in-cylinder-injection type spark-ignition internal combustion engine according to the first example embodiment of the invention;

FIG. 2 is a view showing the bottom surface of the cylinder head of the internal combustion engine shown in FIG. 1;

FIG. 3 is a view showing the bottom surface of the cylinder head of an in-cylinder-injection type spark-ignition internal combustion engine according to the second example embodiment of the invention;

FIG. 4 is a view showing the bottom surface of the cylinder head of an in-cylinder fuel-injection type spark-ignition internal combustion engine according to the third example embodiment of the invention;

FIG. 5 is a vertical cross-sectional view showing the internal combustion engine shown in FIG. 4;

FIG. 6 is a time chart representing a lift pattern of the valve body of the fuel injection valve; and

FIG. 7 is a time chart representing another lift pattern of the valve body of the fuel injection valve.

### DETAILED DESCRIPTION OF THE EXAMPLE EMBODIMENTS

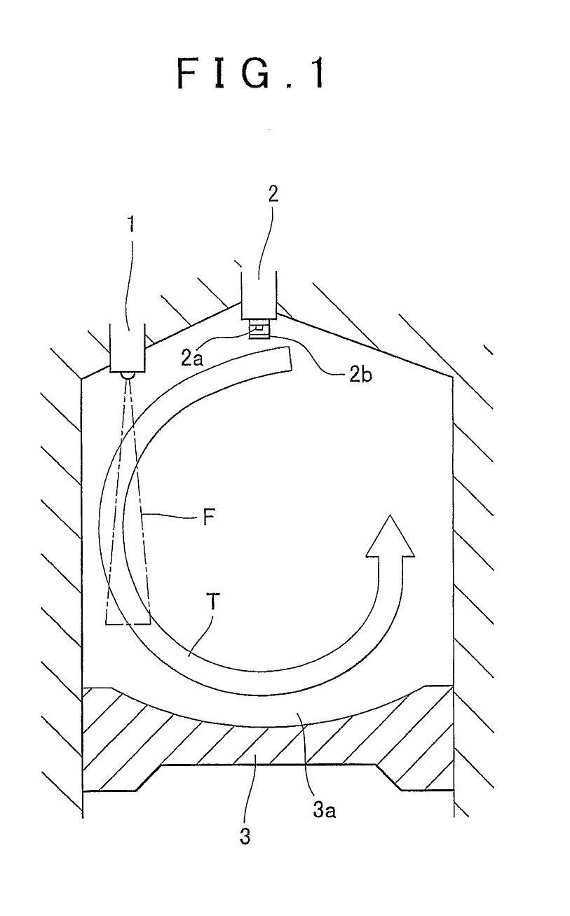

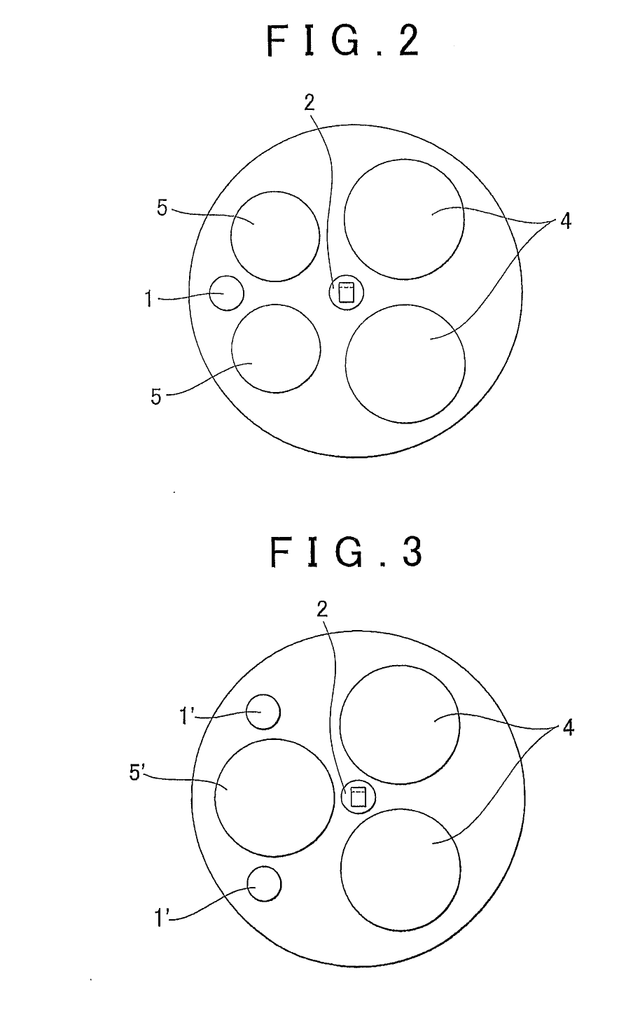

FIG. 1 is a vertical sectional view showing an in-cylinder-injection type spark-ignition internal combustion engine according to the first example embodiment of the invention. FIG. 2 is a view showing the bottom surface of the cylinder head of the internal combustion engine shown in FIG. 1. The internal combustion engine of the first example embodiment has, in each cylinder, a fuel injection valve 1 that is arranged in the exhaust valve side of the upper area of the cylinder and is used to inject fuel directly into the cylinder and an ignition plug 2 that is arranged substantially at the center of the upper area of the cylinder, a piston 3, two intake valves 4 (double intake valve), and two exhaust valves 5 (double exhaust valve).

The fuel injection valve 1 is arranged between the two exhaust valves 5 in the upper area of the cylinder, that is, in the region that is surrounded by the two exhaust valves 5 and the periphery of the upper area of the cylinder and has a specific area. That is, the fuel injection valve 1 can be easily disposed in position in the exhaust valve side of the upper area of the cylinder without increasing the diameter of the cylinder bore.

The internal combustion engine of the first example embodiment performs homogenous combustions by producing homogenous air-fuel mixtures having an air-fuel ratio leaner than the stoichiometric air-fuel ratio and igniting the air-fuel mixtures by the ignition plug 2. When the internal combustion engine is running at a high speed and under a large load, the internal combustion engine needs to produce a large output. In such a state, the internal combustion engine may perform homogenous combustions at a rich or stoichiometric air-fuel ratio. In particular, when performing homogenous combustions at a lean air-fuel ratio, unless the combustion speed is increased by maintaining movement of intake air within the cylinder until the time of ignition, a desired engine output can not be obtained. In view of this, it is desirable to maintain the movement of intake air in the cylinder until the ignition time at the end of a compression stroke by producing a tumble flow T, which flows downward through the exhaust valve side of the cylinder bore and upward through the intake valve side, from the intake air drawn into the cylinder on an intake stroke and maintaining the produced tumble flow until the ignition time.

However, generally speaking, strong tumble flows can not be produced without modifications, such as increasing the wall thickness of the cylinder head and appropriately changing the shape and position of the intake port or providing an intake flow control valve in the intake port. Therefore, even if a cavity 3a, which is partially arc-shaped, is formed in the top surface of the piston 3 to suppress the decrease in the intensity of the tumble flows, as in this example embodiment, the tumble flows easily weaken on a compression stroke and disappear before the ignition time, and therefore, it is impossible to maintain movement of intake air until the ignition time by utilizing the tumble flows.

Meanwhile, in this example embodiment, when a moderate tumble flow T, which is produced in the cylinder on an intake stroke, is flowing downward through the exhaust valve side of the cylinder bore, fuel F is injected downward substantially in the axial direction of the cylinder from the fuel injection valve 1, that is, almost straight downward from the fuel injection valve 1 at the end of the intake stroke, so that the tumbles flow T is intensified by the thrust force of the injected fuel F. The thus intensified tumble flow remains in the cylinder until the ignition time at the end of the compression stroke. As such, movement of intake air can be maintained in the cylinder until the ignition time.

The shape of fuel spray injected fro the fuel injection valve 1 may be set to any arbitral shape, such as the shape of a solid or hollow cone or the shape of a solid column. Alternatively, by providing an arc-slit-shaped injection hole and multiple straight-slit-shaped injection holes in combination, fuel may be sprayed into a shape that is conical and has a relatively small thickness in cross-section or into a shape that appears like a zigzag line and has a relatively small thickness in cross section. Namely, fuel may be injected into any shape as long as the thrust force of fuel spray can be made large enough to accelerate tumble flows in the cylinder. Meanwhile, in the case where fuel is injected such that the injected fuel spreads wider and wider as it proceeds in the cylinder, the direction in which the fuel spreads in the cylinder is preferably such that the fuel does not spread toward the wall of the cylinder bore in FIG. 1 (i.e., the fuel does not spread outwardly in the radial direction of the cylinder bore in FIG. 1). By doing so, the possibility of adherence of the injected fuel to the wall of the cylinder bore, which may cause dilution of the engine oil, can be reduced.

In the case of an in-cylinder-injection type spark-ignition internal combustion engine in which a fuel injection valve is arranged substantially at the center of the upper area of the cylinder, fuel needs to be injected toward the wall of the cylinder bore from the fuel injection valve (i.e., obliquely downward from the fuel injection valve) to intensify a tumble flow by the fuel spray, and therefore the fuel can easily adhere to the wall of the cylinder bore. Further, in the internal combustion engine of the example embodiment, because only the ignition plug 2 is disposed at the center of the upper area of the cylinder, relatively large intake and exhaust valves can be used as the intake valves 4 and the exhaust valves 5, and therefore the intake and exhaust efficiencies improve accordingly.

In the example embodiment, the fuel injection valve 1 has the slit-shaped injection hole and injects fuel into the shape of a fan having a relatively small thickness, such that the thickness direction of the fan-shaped fuel spray F matches a radial direction of the cylinder bore in FIG. 1 and the directions in which the fuel spray F laterally extends does not match any radial directions of the cylinder bore in FIG. 1. This reduces the possibility that the fuel spray F would adhere to the wall of the cylinder bore.

The ignition plug 2 has a center electrode 2a and a plate electrode 2b that is formed in the shape of the letter “L”. In this example embodiment, the ignition plug 2 is arranged such that the lateral direction of the plate electrode 2b in FIG. 1 is substantially parallel to the flow direction of the tumble flow. This arrangement reduces the possibility that the tumble flow would weaken by colliding with the plate electrode 2b, as compared to the case in which the ignition plug 2 is arranged such that the lateral direction of the plate electrode 2b crosses the flow direction of the tumble flow, for example.

In the example embodiment, in other words, the ignition plug 2 is arranged such that the longitudinal direction of the plate electrode 2b in FIG. 1 crosses the flow direction of the tumble flow T. However, because the thickness of the plate electrode 2b is small and therefore the tumble flow T hardly weakens due to the presence of the plate electrode 2b. Note that if the plate electrode 2b is reversed from the position shown in FIG. 1 by 180 degree about its axis, the plate electrode 2b hardly weakens the tumble flow T as in the case described above. In the case where the ignition plug 2 is an ignition plug with two plate electrodes facing each other, too, it is preferable that the ignition plug 2 be arranged such that the longitudinal directions of the plate electrodes cross the flow direction of the tumble flow T and the lateral directions of the plate electrodes are substantially parallel to the flow direction of the tumble flow T. With such arrangement of the ignition plug 2, the electric arc produced between the electrodes 2a, 2b at the ignition is readily extended by the tumble flow T toward the downstream side thereof, which makes it easier to ignite homogenous air-fuel mixtures in the cylinder.

In order to perform homogenous combustions at desired air-fuel ratios, the fuel injection valve 1 is controlled to inject a required amount of fuel at the end of each intake stroke (for example, the crank angle at which to start fuel injection is set according to the fuel injection amount such that the crank angle at which to finish the fuel injection will be at a point near the bottom dead center on an intake stroke, or the fuel-injection start crank angle is set to a point at the end of each intake stroke regardless of the fuel injection amount). Thus, as the required amount of fuel increases, the tumble flow T is further intensified.

When the required amount of fuel is large, a portion of the required fuel may be injected beforehand in the initial or intermediate stage of each intake stroke (or in two or more steps of each intake stroke). By doing so, the amount of fuel to be injected at the end of each intake stroke can be reduced, and thus the degree to which the tumble flow T is intensified can be controlled.

In the meantime, the internal combustion engine according to this example embodiment is, as described above, an in-cylinder-injection type spark-ignition internal combustion engine that performs homogenous combustions by directly injecting fuel into the respective cylinders. Thus, a required amount of fuel can be supplied into each of the cylinders in a reliable manner, and therefore it is not necessary to inject fuel more than required in order to compensate for adherence of fuel to the wall of the intake port, unlike in an internal combustion engine that injects fuel into the intake port. Further, when the load on the internal combustion engine is small, stratified combustions may be performed by producing air-fuel mixtures only around the ignition plug 2 by injecting fuel in the latter half of each compression stroke. In this case, the cavity 3a is formed in the top surface of the piston 3 such that its capacity is larger in the side closer to the exhaust valves 4. Thus, fuel sprays can be guided by the cavity 3a to around the ignition plug 2.

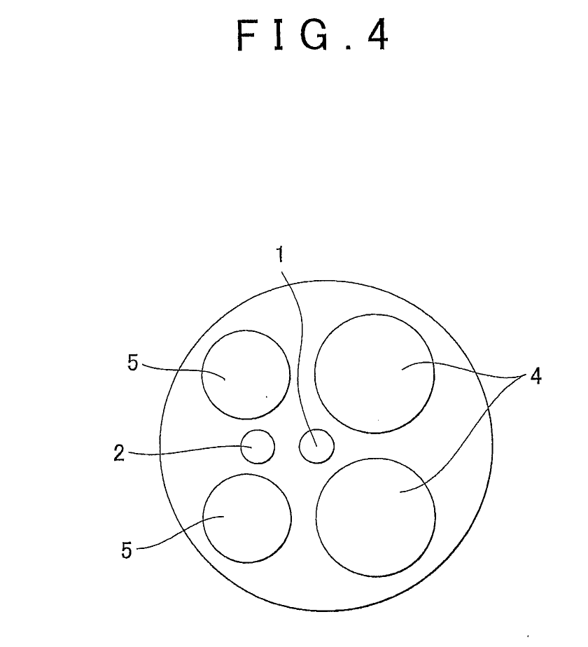

FIG. 3 is a view showing the bottom surface of the cylinder head of an in-cylinder-injection type spark-ignition internal combustion engine according to the second example embodiment of the invention. In the following, only the differences from the first example embodiment will be described. The internal combustion engine of the second example embodiment is a single exhaust valve type engine, in which two fuel injection valves 1′ are provided in the regions, each having a specific area, on both sides of the single exhaust valve 5′ in the upper area of each cylinder, respectively. That is, in this configuration, the two fuel injection valves 1′ can be easily provided in the exhaust valve side of the upper area of each cylinder without increasing the diameter of the cylinder bore.

In the internal combustion engine of the second example embodiment, when a moderate tumble flow that is produced on an intake stroke is flowing downward through the exhaust valve side of the cylinder bore, the tumble flow is intensified by the thrust force of the fuel injected downward substantially in the axial direction of the cylinder from each of the two fuel injection valves 1′, that is, almost straight downward from each fuel injection valve 1′. Namely, in the second example embodiment, the tumble flow are intensified by the two fuel sprays, so that the tumble flow can remain until the ignition time at the end of each compression stroke and thus the movement of intake air can be maintained in the cylinder until that time.

While the foregoing two example embodiments are applied to an internal combustion engine that performs homogenous combustions at air-fuel ratios leaner than the stoichiometric air-fuel ratio, the invention is not limited to such application, but can also be effectively applied to, for example, an in-cylinder-injection type spark-ignition internal combustion engine that performs homogenous combustions at the stoichiometric air-fuel ratio or at rich air-fuel ratios. In such an internal combustion engine, too, it is effective to increase the combustion speed by maintaining the movement of intake air until the ignition time through the intensifying of tumble flows.

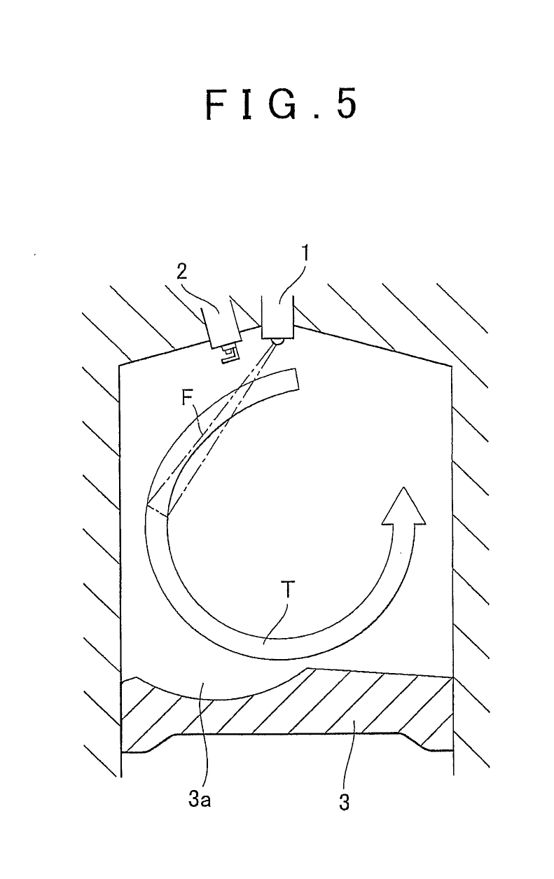

FIG. 4 is a view showing the bottom surface of the cylinder head of an in-cylinder fuel-injection type spark-ignition internal combustion engine according to the third example embodiment of the invention. FIG. 5 is a vertical cross-sectional view showing the internal combustion engine shown in FIG. 4. The internal combustion engine of the third example embodiment has, in each cylinder, a fuel injection valve 1 that is arranged substantially at the center of the upper area of the cylinder to inject fuel directly into the cylinder, an ignition plug 2 that is arranged near the fuel injection valve 1, a piston 3, a pair of intake valves 4, and a pair of exhaust valves 5.

The internal combustion engine of the third example embodiment performs homogenous combustion by producing homogenous air-fuel mixtures having an air fuel ratio leaner than the stoichiometric air-fuel ratio in the cylinder and igniting the air-fuel mixtures by the ignition plug 2. The lean air-fuel ratio for this homogenous combustion is set so as to make the amount of NOx produced by the combustion relatively small (e.g., 20). When the internal combustion engine is running at a high speed and under a large load, the internal combustion engine needs to produce a large output. In such a state, the internal combustion engine may perform homogenous combustions at a rich or stoichiometric air-fuel ratio. Also, in the case where a NOx adsorbing catalyst unit that adsorbs NOx under a fuel-lean atmosphere is provided in the internal combustion engine, when the NOx adsorbed in the NOx adsorbing catalyst needs to be released and removed through reductions, homogenous combustions are performed at prescribed rich air-fuel ratios. Especially, during homogenous combustion at a lean air-fuel ratio, unless the combustion speed is increased by maintaining movement of intake air in the cylinder until the ignition time, a desired engine output can not be obtained. In view of this, it is desirable to maintain the movement of intake air in the cylinder until the ignition time at the end of a compression stroke by producing a tumble flow, which flows downward through the exhaust valve side of the cylinder bore and upward through the intake valve side, from the intake air drawn into the cylinder on an intake stroke and maintaining the produced tumble flow until the ignition time.

However, generally speaking, strong tumble flows can not be produced without modifications such as increasing the wall thickness of the cylinder head and appropriately changing the shape and position of the intake port or providing an intake flow control valve in the intake port. Therefore, even if a cavity 3a, which is partially arc-shaped, is formed in the top surface of the piston 3 to suppress the decreases in the intensity of the tumble flows, as in this example embodiment, the tumble flows easily weaken on a compression stroke and disappear before the ignition time, and therefore, it is impossible to maintain movement of intake air until the ignition time by utilizing tumble flows. In this example embodiment, therefore, the tumble flow T is intensified by the thrust force of fuel F that is injected from the fuel injection valve 1 to the exhaust valve side of the cylinder bore at the end of each intake stroke. The tumble flow thus produced stably remains until the ignition time, and therefore the movement of intake air can be maintained in the cylinder until the ignition time.

In the third example embodiment, for example, the fuel injection valve 1 has a slit-shaped injection hole and injects fuel into the shape of a fan having a relatively small thickness such that the center lateral plane of the fuel spray F extends downward in parallel to the flow direction of the tumble flow T and substantially matches a vertical plane extending through the axis of the cylinder. This cross section in FIG. 5 represents the vertical plane extending through the axis of the cylinder and the cross section of the fuel spray F in FIG. 5 represents the center lateral plane of the fuel spray F, Further, the fuel injection valve 1 may be a fuel injection valve that has a circular fuel injection hole and injects fuel into the shape of a column or a cone.

In the meantime, the intensity of the tumble flow T produced in the cylinder on each intake stroke varies as the kinetic energy of the intake air drawn into the cylinder changes in accordance with the operation conditions of the internal combustion engine. The kinetic energy of intake air is represented as ½ mv² where “m” is the mass of intake air drawn per unit time and “v” is the flow rate of intake air. The kinetic energy of intake air increases as the engine speed increases and as the engine load increases. That is, the kinetic energy of intake air drawn into the cylinder is large when the internal combustion engine is running at a high speed and under a large load and is small when the internal combustion engine is running at a low speed and under a small load. Also, the kinetic energy of intake air increases as the air-fuel ratio of combusted air-fuel mixture, which is one of the operation conditions of the internal combustion engine, is leaner. Also, in the case where the air-fuel ratio of combusted air-fuel mixture is switched among a prescribed lean air-fuel ratio, the stoichiometric air-fuel ratio, and a prescribed rich air-fuel ratio, the kinetic energy of intake air is smallest at the prescribed lean air-fuel ratio, and increases as the air-fuel ratio is switched from the prescribed lean air-fuel ratio to the stoichiometric air-fuel ratio, and further increases as the air-fuel ratio is switched from the stoichiometric air-fuel ratio to the prescribed rich air-fuel ratio. The larger the kinetic energy of intake air drawn into the cylinder, the higher the intensity of the tumble flow T to be produced. Therefore, in the case where the injection rate of the fuel spray F injected from the fuel injection valve 1 is kept at a relatively low rate, when a relatively strong tumble flow T is produced, the tumble flow T can not be intensified by the fuel spray F. On the other hand, in the case where the injection rate is kept at a relatively high rate, when a relatively weak tumble flow T is produced, the fuel spray F may penetrate the tumble flow T and adhere to the wall of the cylinder bore, diluting the engine oil.

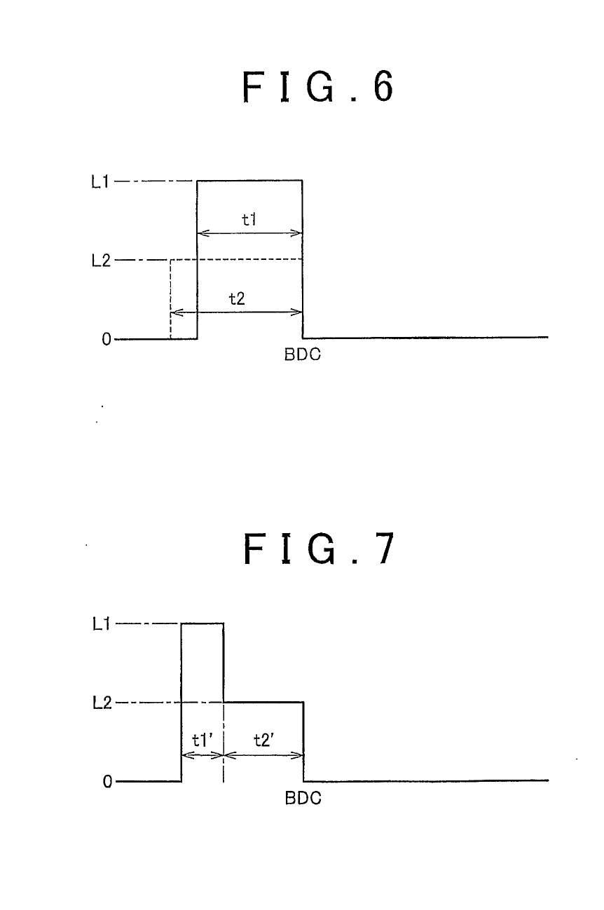

Meanwhile, in the example embodiment, the lift of the valve body of the fuel injection valve 1 can be variably controlled in at least two steps: a large lift and a small lift. Thus, when the kinetic energy of intake air drawn into the cylinder is equal to or greater than a reference valve, the valve body is lifted up by the large lift L1 as indicated by the solid line in FIG. 6. That is, when the kinetic energy of intake air is equal to or greater than the reference value, a relatively strong tumble flow is produced in the cylinder. In this case, by lifting up the valve body of the fuel injection valve 1 by the large lift L1, the injection rate increases and thus the thrust force of the fuel spray F increases accordingly. As a result, the tumble flow can be sufficiently intensified by the fuel spray F.

On the other hand, when the kinetic energy of intake air drawn into the cylinder is less than the reference valve, the valve body of the fuel injection valve 1 is lifted up by the small lift L2 as indicated by the dotted line in FIG. 6. That is, when the kinetic energy of intake air drawn into the cylinder is less than the reference valve, a relatively weak tumble flow is produced in the cylinder. In this case, by lifting up the valve body of the fuel injection valve 1 by the small lift L2, the injection rate decreases and thus the thrust force of the fuel spray F decreases accordingly. This reduces the possibility that the fuel spray F would penetrate the tumble flow and collide with and then adhere to the wall of the cylinder bore. Further, such a relatively weak tumble flow can be reliably intensified by the fuel spray F even though the thrust force of the fuel spray F is low.

In the third example embodiment, the time for finishing fuel injection is fixed to the bottom dead center (BDC) on each intake stoke. Thus, the duration for which the fuel injection valve is opened (t1 or t2 in FIG. 6) is calculated in consideration of the injection rate such that a required amount of fuel, which reflects the operation conditions of the internal combustion engine, is injected into the cylinder, and the time for starting the fuel injection is then set so as to achieve the calculated valve-open duration. Note that the valve-open duration increases as the fuel injection rate increases, provided that the injected fuel amount is the same.

When the fuel injection rate is decreased and the fuel injection duration (valve-open duration) is increased, it makes it easier for the injected fuel to be spread by the tumble flow over the entire area in the cylinder, and this is desirable to obtain good homogenous air-fuel mixtures in the cylinder. As such, it is also possible to change the injection rate in multiple steps such that the injection rate decreases as the intensity of the tumble flow decreases. To accomplish this, the lift of the valve body of the fuel injection valve 1 may be controlled in a larger number of steps using a piezo actuator etc.

Here, it is assumed that the lift of the valve body of the fuel injection valve 1 can be controlled only in two steps of the large lift L1 and the small lift L2. In this case, by opening the fuel injection valve 1 first by the large lift L1 and then by the small lift L2 in a row as indicated in FIG. 7, the entire injection rate achieved in this injection is a rate between the maximum injection rate that is achieved when the valve body of the fuel injection valve 1 is lifted up by the large lift L1 only and the minimum injection rate that is achieved when the valve body of the fuel injection valve 1 is lifted up by the small lift L2 only. Needless to say, when using the two valve lifts L1, L2 in a row, the valve body of the fuel injection valve 1 may either be lifted up first by the large lift L1 and then by the small lift L2 or vice-versa.

FIG. 7 illustrates a state in which a half of the required amount of fuel, which reflects the operation conditions of the internal combustion engine, is injected by opening the fuel injection valve 1 by the large lift L1 and another half is injected by opening the fuel injection valve 1 by the small lift L2. In this case, the entire injection rate of this fuel injection is the middle between the maximum injection rate and the minimum injection rate, and the valve-open duration t1′ during which the fuel injection valve 1 is opened by the large lift L1 to inject the first half of fuel is shorter than the valve-open duration t2′ during which the fuel injection valve 1 is opened by the small lift L2 to inject the second half of fuel. The time for starting this fuel injection is set such that the piston reaches the bottom dead center on the intake stroke at the end of the fuel injection performed over the valve duration t1′ and the valve duration t2′ in a row.

In the above case, the entire injection rate can be made higher than the middle between the maximum injection rate and the minimum injection rate by making the fuel amount for the injection with the large lift larger than a half of the required fuel amount and making the fuel amount for the injection with the small lift smaller than a half of the required fuel amount by an amount corresponding to the increase in the fuel amount for the injection with the large lift. Conversely, the entire injection rate can be made lower than the middle between the maximum injection rate and the minimum injection rate by making the fuel amount for the injection with the large lift smaller than a half of the required fuel amount and making the fuel amount for the injection with the small lift larger than a half of the required fuel amount by an amount corresponding to the decrease in the fuel amount for the injection with the large lift.

As such, the entire injection rate can be increased by increasing the ratio of the fuel amount for injection with the large valve lift to the required fuel amount (while reducing the ratio of the fuel amount for the injection with the small valve lift accordingly), and the entire injection rate can be reduced by reducing the ratio of the fuel amount for injection with the large valve lift to the required fuel amount (while increasing the ratio of the fuel amount for the injection with the small valve lift accordingly). Thus, the entire fuel injection for each fuel injection can be adjusted such that the entire fuel injection decreases as the intensity of the tumble flow is smaller. Therefore, it is possible to intensify each tumble flow in a reliable manner while preventing the fuel spray F from penetrating the tumble flow. Also, the thrust force of the fuel spray is not increased unnecessarily, and this makes it easier for the injected fuel to be spread by the tumble flow, which is desirable to produce good homogenous air-fuel mixtures.

While the time for finishing fuel injection is set to the bottom dead center on each intake stroke in the foregoing example embodiments, the invention is not limited to this. That is, the time for finishing fuel injection may be set to other point close to the bottom dead center on each intake stroke as long as fuel injection is mainly performed at the end of each intake stroke.

1. An in-cylinder-injection type spark-ignition internal combustion engine, comprising:
a fuel injection valve; and
an ignition plug, wherein:
the fuel injection valve and the ignition plug are arranged in an upper area of the internal combustion engine, and the fuel injection valve is adapted to inject fuel substantially in a flow direction of a tumble flow that swirls in the cylinder by flowing downward through an exhaust valve side of a cylinder bore of the cylinder and upward through an intake valve side of the cylinder bore, so as to intensify the tumble flow.

2. The in-cylinder-injection type spark-ignition internal combustion engine according to claim 1, wherein the fuel injection valve is arranged in an exhaust valve side of the upper area of the cylinder and is adapted to inject fuel downward substantially in the axial direction of the cylinder.

3. The in-cylinder-injection type spark-ignition internal combustion engine according to claim 2, wherein:
the internal combustion engine includes two exhaust valves; and
the fuel injection valve is arranged between the two exhaust valves.

4. The in-cylinder-injection type spark-ignition internal combustion engine according to claim 2, wherein:
the internal combustion engine includes a single exhaust valve;
the fuel injection valve is provided in plurality; and
the fuel injection valves are provided on both sides of the single exhaust valve, respectively.

5. The in-cylinder-injection type spark-ignition internal combustion engine according to claim 1, wherein the fuel injection valve is arranged substantially at the center of the upper area of the cylinder so as to inject fuel to the exhaust valve side of the cylinder bore at an end of an intake stroke and is adapted to inject fuel at a lower injection rate when a kinetic energy of intake air drawn into the cylinder is small than when the kinetic energy is large.

6. The in-cylinder-injection type spark-ignition internal combustion engine according to claim 5, wherein the injection rate is reduced as the kinetic energy decreases.

7. The in-cylinder-injection type spark-ignition internal combustion engine according to claim 6, wherein:
the lift of a valve body of the fuel injection valve is controlled in two steps of a large lift and a small lift; and
the fuel injection valve is adapted to inject fuel at a maximum injection rate by lifting up the valve body by the large lift, at a minimum injection rate by lifting up the valve body by the small lift, and at an injection rate between the maximum injection rate and the minimum injection rate by lifting up the valve body first by one of the large lift and the small lift and then by the other in a row.

8. The in-cylinder-injection type spark-ignition internal combustion engine according to claim 7, wherein the time for finishing injection of the fuel is set to a point close to the bottom dead center on an intake stroke of the internal combustion engine.

9. The in-cylinder-injection type spark-ignition internal combustion engine according to claim 8, wherein the time for starting injection of the fuel is determined based on a required fuel amount that is determined in accordance with operation conditions of the internal combustion engine and the injection rate.

10. The in-cylinder-injection type spark-ignition internal combustion engine according to claim 5, wherein the kinetic energy increases as a load on the internal combustion engine increases.

11. The in-cylinder-injection type spark-ignition internal combustion engine according to claim 5, wherein the kinetic energy increases as an engine speed of the internal combustion engine increases.

12. The in-cylinder-injection type spark-ignition internal combustion engine according to claim 7, wherein the fuel injection valve is adapted to inject a required fuel amount, which is determined in accordance with operation conditions of the internal combustion engine, at an injection rate between the maximum injection rate and the minimum injection rate by injecting a portion of the required fuel amount by lifting up the valve body by one of the large lift and the small lift and then injecting the rest of the required fuel amount by lifting up the valve body by the other of the large lift and the small lift.

13. The in-cylinder-injection type spark-ignition internal combustion engine according to claim 7, wherein the fuel injection valve injects fuel by lifting up the valve body by the large lift when the kinetic energy is larger than a reference value, and injects fuel by lifting up the valve body by the small lift when the kinetic energy is equal to or smaller than the reference value.
